(19) United States
(12) Patent Application Publication
(10) Pub. No.: US 2022/0057095 A1
(43) Pub. Date: Feb. 24, 2022

(54) AIR-CONDITIONING COOLING ENERGY APPARATUS MANAGEMENT APPARATUS

(71) Applicant: Mitsubishi Electric Corporation, Tokyo (JP)

(72) Inventor: Yosuke HASHIMOTO, Tokyo (JP)

(21) Appl. No.: 17/599,707

(22) PCT Filed: Jun. 5, 2019
(86) PCT No.: PCT/JP2019/022286

§ 371 Date: Sep. 29, 2021

(51) Int. Cl. F24F 11/38; G08B 21/18; G08B 5/22; F24F 11/58

(52) U.S. Cl. CPC F24F 11/38; F24F 11/58; G08B 5/22; G08B 21/187

(57) ABSTRACT

An air-conditioning cooling energy apparatus management apparatus includes: a setting input unit that sets and inputs control information to determine a transmission destination of notification information indicating occurrence of a failure in an air-conditioning cooling energy apparatus; a storage unit that stores the control information set by the setting input unit; a communication unit that receives information on the failure from the air-conditioning cooling energy apparatus and transmits the notification information indicating occurrence of the failure; and a transmission destination determination unit that determines the transmission destination of the notification information based on the control information and a failure level based on the information on the failure that is received by the communication unit. The communication unit receives the information on the failure from the air-conditioning cooling energy apparatus and transmits the notification information to the transmission destination determined by the transmission destination determination unit.

### CROSS REFERENCE TO RELATED APPLICATION

This application is a U.S. national stage application of International Patent Application No. PCT/JP2019/022286 filed on Jun. 5, 2019, the disclosure of which is incorporated herein by reference.

### TECHNICAL FIELD

The present disclosure relates to an air-conditioning cooling energy apparatus management apparatus that manages an air-conditioning cooling energy apparatus.

### BACKGROUND

In general, in the case where a failure occurs in an apparatus installed in a building, it is required to promptly make a notification indicating the failure. As a method of making such a notification, in a given notification method, information is sent to an information terminal of each of users registered in advance (for example, see Patent Literature 1).

In the case where a failure occurs in an apparatus installed in a building, an information notification apparatus described in Patent Literature 1 transmits information to information terminals of users whose are present in a set area where the apparatus is installed, in order to ask the users to evacuate.

### PATENT LITERATURE

Patent Literature 1: Japanese Unexamined Patent Application Publication No. 2017-63382

Whatever failure occurs in the apparatus, the information notification apparatus described in Patent Literature 1 transmits E-mail regarding the failure to the information terminals of the users who are present in the set area of the apparatus, without considering a failure level indicating the degree of importance of the failure in the apparatus to the E-mail. Thus, even in the case where a slight abnormality occurs in the apparatus, E-mail is transmitted to the information terminals of the users, and as a result each of the information terminals receives a larger number of E-mail. Consequently, the user may overlook E-mail regarding a failure even when the degree of importance of the failure is high. In addition, the load for the user to check E-mail increases.

### SUMMARY

The present disclosure is applied to solve the above problem, and relates to an air-conditioning cooling energy apparatus management apparatus that is capable of making a notification indicating a failure only when the failure level of the failure is to be noticed, that is, a notification indicating only a failure of a failure level that a user needs to know.

An air-conditioning cooling energy apparatus management apparatus according to an embodiment of the present disclosure includes: a setting input unit that sets control information for use in determination of a transmission destination of notification information indicating occurrence of a failure in an air-conditioning cooling energy apparatus, when the control information is input to the setting input unit; a storage unit that stores the control information set by the setting input unit; a communication unit that receives information on the failure from the air-conditioning cooling energy apparatus and transmits the notification information indicating occurrence of the failure; and a transmission destination determination unit that determines the transmission destination of the notification information on the basis of the control information and a failure level based on the information on the failure that is received by the communication unit. The communication unit transmits the notification information to the transmission destination determined by the transmission destination determination unit, when receiving the information on the failure from the air-conditioning cooling energy apparatus.

In an air-conditioning cooling energy apparatus management apparatus according to an embodiment of the present disclosure, it is possible to make a notification indicating occurrence of only a failure whose failure level needs to be known by a user.

### BRIEF DESCRIPTION OF DRAWINGS

FIG. 1 is a configuration diagram illustrating an example of the configuration of a management system in which an air-conditioning cooling energy apparatus management apparatus according to Embodiment 1 is provided.

FIG. 2 is a block diagram illustrating an internal configuration of the air-conditioning cooling energy apparatus management apparatus according to Embodiment 1.

FIG. 3 is a diagram illustrating an example of a first data table in which first control information set by a setting input unit of the air-conditioning cooling energy apparatus management apparatus according to Embodiment 1 is indicated.

FIG. 4 is a diagram illustrating an example of each of second data tables in which second control information set by the setting input unit of the air-conditioning cooling energy apparatus management apparatus according to Embodiment 1 is indicated.

FIG. 5 is a timing chart illustrating a procedure of processing that is performed by the air-conditioning cooling energy apparatus management apparatus according to Embodiment 1, when a level-1 failure occurs.

FIG. 6 is a timing chart illustrating a procedure of processing that is performed by the air-conditioning cooling energy apparatus management apparatus according to Embodiment 1, when a level-4 failure occurs.

FIG. 7 is a diagram illustrating an example of an input section that is used when a failure level is changed and displayed on a display unit of the air-conditioning cooling energy apparatus management apparatus according to Embodiment 1.

FIG. 8 is a diagram illustrating an example of an input section that is used when failure levels displayed on the display unit of the air-conditioning cooling energy apparatus management apparatus according to Embodiment 1 are changed.

FIG. 9 is a configuration diagram illustrating an example of the configuration of a management system in which air-conditioning cooling energy apparatus management apparatuses according to Embodiment 2 are provided.

FIG. 10 is a diagram illustrating an example of a first data table in which first control information set by a setting input unit of the air-conditioning cooling energy apparatus management apparatus according to Embodiment 2 is indicated.

FIG. 11 is a diagram illustrating an example of a second data table in which second control information set by the setting input unit of the air-conditioning cooling energy apparatus management apparatus according to Embodiment 2 is indicated.

### DETAILED DESCRIPTION

In the following, an air-conditioning cooling energy apparatus management apparatus according to each of embodiments that is applied to management of air-conditioning cooling energy apparatuses installed in a building or buildings will be described with reference to the drawings. However, the descriptions concerning the embodiments are not limiting, and various modification can be made without departing from the gist of the present disclosure. The present disclosure covers all possible combinations of configurations described below regarding the embodiments. Management systems as illustrated in the figures in the drawings are examples of a system to which the air-conditioning cooling energy apparatus management apparatus according to each of the embodiments is applied. The air-conditioning cooling energy apparatus management apparatus according to each of the embodiments is not limited to the air-conditioning cooling energy apparatus management apparatuses and management systems as illustrated in the figures. In each of the figures, components that are denoted by the same reference signs as a previous figure or figures are the same as or equivalent to those in the previous figure or figures, and the same is true of the entire text of the specification. It should be noted that for example, relative relationships in size or shape between components may be different from those between actual components.

### Embodiment 1

An air-conditioning cooling energy apparatus management apparatus according to Embodiment 1 will be described with reference to the figures.

### [Configuration of Management System]

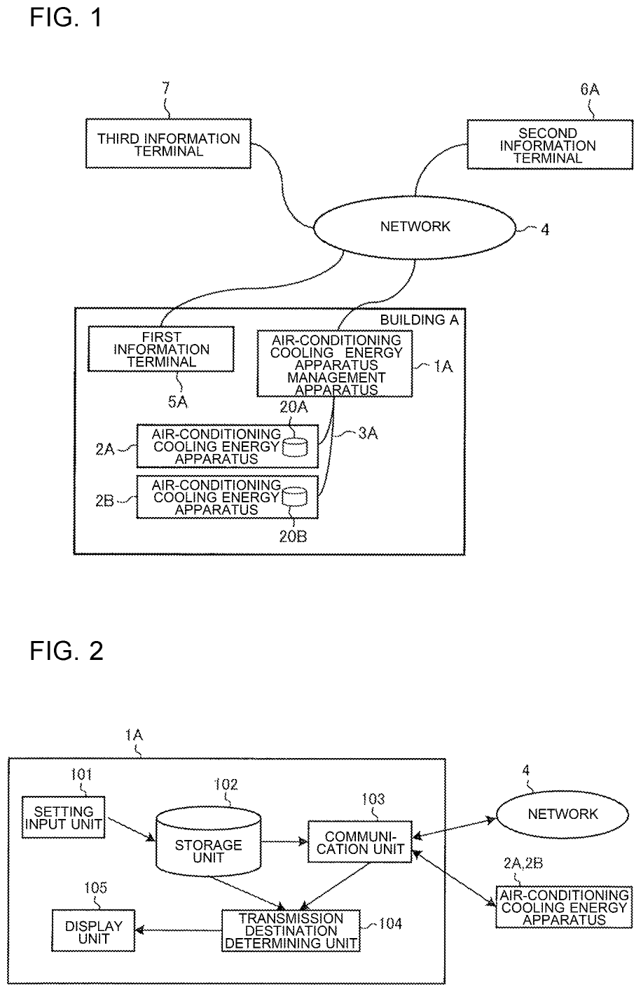

FIG. 1 is a configuration diagram illustrating an example of the configuration of a management system in which the air-conditioning cooling energy apparatus management apparatus according to Embodiment 1 is provided. As illustrated in FIG. 1, the management system according to Embodiment 1 includes an air-conditioning cooling energy apparatus management apparatus 1A, air-conditioning cooling energy apparatuses 2A and 2B, a first information terminal 5A, a second information terminal 6A, and a third information terminal 7. The air-conditioning cooling energy apparatuses 2A and 2B are apparatuses to be managed by the air-conditioning cooling energy apparatus management apparatus 1A.

As illustrated in FIG. 1, the air-conditioning cooling energy apparatus management apparatus 1A, the air-conditioning cooling energy apparatuses 2A and 2B, and the first information terminal 5A are installed in a building A. The first information terminal 5A is an information terminal for use by an administrator of the building A. Each of the air-conditioning cooling energy apparatuses 2A and 2B is, for example, an air-conditioning apparatus that performs both cooling and heating, an air-conditioning apparatus that performs cooling only, a fan, or a dehumidifier. The air-conditioning cooling energy apparatus 2A includes a storage device 20A, and the air-conditioning cooling energy apparatus 2B includes a storage device 20B. In this case, the first information terminal 5A is described as a fixed terminal; however, the first information terminal 5A may be a mobile terminal that is carried by the administrator of the building A.

The second information terminal 6A and the third information terminal 7 are installed in an office for a maintenance contractor that performs maintenance of the air-conditioning cooling energy apparatuses 2A and 2B. The second information terminal 6A is used by a person in the maintenance contractor who is in charge of the building A. The third information terminal 7 is used by a responsible person in the maintenance contractor. In this case, the second information terminal 6A is a fixed terminal, but may be a mobile terminal that is carried by the person who is in charge of the building A, in the maintenance contractor. Similarly, in this case, the third information terminal 7 is a fixed terminal, but may be a mobile terminal that is carried by the responsible person in the maintenance contractor.

The air-conditioning cooling energy apparatus management apparatus 1A is connected to the air-conditioning cooling energy apparatuses 2A and 2B by communication lines 3A. The communication lines 3A are installed in the building A. The air-conditioning cooling energy apparatus management apparatus 1A is connected to the first information terminal 5A, the second information terminal 6A, and the third information terminal 7 via a network 4. The network 4 may be an information network such as the Internet or may be a dedicated network provided between the building A and the maintenance contractor.

In the case where a failure occurs in the air-conditioning cooling energy apparatus 2A or 2B, the air-conditioning cooling energy apparatus management apparatus 1A transmits notification information indicating the failure to at least one of the first information terminal 5A, the second information terminal 6A, and the third information terminal 7 on the basis of the level of the failure.

It should be noted that although it is described above that air-conditioning cooling energy apparatuses 2A and 2B are provided; however, the number of air-conditioning cooling energy apparatuses is not limited to two and may be any number. In this case, the first to third information terminals 5A, 6A, and 7 are described as examples of information terminals. Thus, although it is not limiting that the number of information terminals is three, that is, the number of information terminals is not limited to three and may be any number.

### [Configuration of Air-Conditioning Cooling Energy Apparatus Management Apparatus]

FIG. 2 is a block diagram illustrating an internal configuration of the air-conditioning cooling energy apparatus management apparatus 1A according to Embodiment 1. As illustrated in FIG. 2, the air-conditioning cooling energy apparatus management apparatus 1A includes a setting input unit 101, a storage unit 102, a communication unit 103, a transmission destination determination unit 104, and a display unit 105.

The setting input unit 101 serves as an interface that receives a signal from the outside. The setting input unit 101 receives control information input by a user and sets the control information. The control information is information that is used when the air-conditioning cooling energy apparatus management apparatus 1A performs a control. The air-conditioning cooling energy apparatus management apparatus 1A determines, based on the control information, a transmission destination or transmission destinations of notification information indicating occurrence of a failure in the air-conditioning cooling energy apparatus 2A or 2B, that is, determines to which terminal or terminals the notification information is to be transmitted. The control information includes first control information and second control information. The first control information is information in which correspondence relationships between the failure levels and the notification-information transmission destinations are determined. The transmission destination or transmission destinations of the notification information are indicated by, for example, an E-mail address, a telephone number, or a social networking service (SNS) account. In the case where a transmission destination of notification information is indicated by a telephone number, the notification information is transmitted using short message service (SMS). The second control information is information in which correspondence relationships between failure kinds and the failure levels is determined. The setting input unit 101 includes an input device or devices such as a mouse and/or a keyboard and a reception device including a reception processing circuit that performs reception processing on data input by the input device.

The storage unit 102 stores the control information set by the setting input unit 101. The storage unit 102 includes a storage device such as a memory.

The communication unit 103 serves as an interface that enables the air-conditioning cooling energy apparatus management apparatus 1A to communicate with the network 4 and with the air-conditioning cooling energy apparatuses 2A and 2B. In the case where a failure occurs in the air-conditioning cooling energy apparatus 2A, the communication unit 103 receives information on the failure from the air-conditioning cooling energy apparatus 2A via an associated one of the communication lines 3A. Similarly, in the case where a failure occurs in the air-conditioning cooling energy apparatus 2B, the communication unit 103 receives information on the failure from the air-conditioning cooling energy apparatus 2B via an associated one of the communication lines 3A. The communication unit 103 transmits notification information to a transmission destination or transmission destinations determined by the transmission destination determination unit 104, which will be described later, via the network 4.

The transmission destination determination unit 104 determines a transmission destination or transmission destinations of the notification information indicating the failure, on the basis of the control information stored in the storage unit 102 and a failure level based on the information on the failure that is transmitted from the air-conditioning cooling energy apparatus 2A or 2B to the communication unit 103. The transmission destination or transmission destinations of the notification information are selected and determined from among the first information terminal 5A, the second information terminal 6A, and the third information terminal 7 on the basis of the control information.

The display unit 105 displays control information on the air-conditioning cooling energy apparatus management apparatus 1A that is stored in the storage unit 102. The display unit 105 includes a display device such as a display.

### [Operation of Air-Conditioning Cooling Energy Apparatus Management Apparatus]

Next, the operation of the air-conditioning cooling energy apparatus management apparatus 1A according to Embodiment 1 will be described.

### [Setting of Control Information]

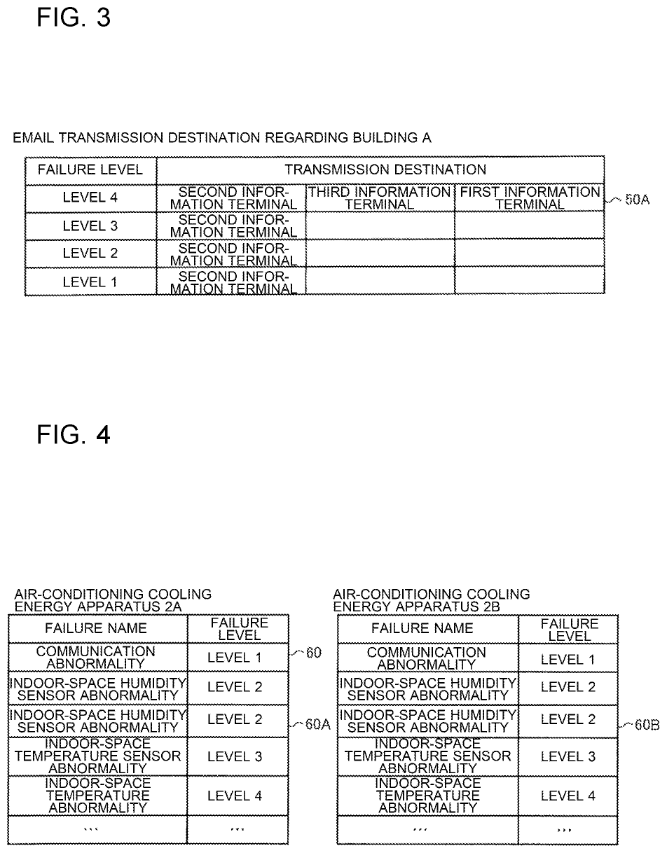

A control information setting operation that is performed using the setting input unit 101 will be described using FIGS. 3 and 4. Setting of the control information in the setting operation is initial setting.

FIG. 3 is a diagram illustrating an example of a first data table 50A in which the first control information set by the setting input unit 101 of the air-conditioning cooling energy apparatus management apparatus 1A according to Embodiment 1 is indicated. As described above, in the first control information, the correspondence relationships between the failure levels and the notification-information transmission destinations are determined. Thus, as illustrated in FIG. 3, the first data table 50A indicates, as the first control information, failure levels and notification-information transmission destinations in association with each other. It should be noted that regarding the failure levels in the first data table 50A, level 1 indicates the level of a slightest failure, and the higher the level becomes, the higher the degree of importance of the failure becomes. In this case, the number of levels is four and level 4 is the highest level; however, the number of levels is not limited to four and may be any number. In the example as illustrated in FIG. 3, the second information terminal 6A, the third information terminal 7, and the first information terminal 5A are set as notification-information transmission destinations in the case where the failure level is level 4. Furthermore, the second information terminal 6A is set as the notification-information transmission destination in the case where the failure level is any of levels 1 to 3. The first data table 50A is stored in the storage unit 102.

FIG. 4 is a diagram indicating an example of each of second data tables 60 in which second control information set by the setting input unit 101 of the air-conditioning cooling energy apparatus management apparatus 1A according to Embodiment 1 is indicated. In the second control information, correspondence relationships between the failure kinds and the failure levels are determined as described above. Thus, the second data tables 60 store, as the second control information, failure name information indicating the kinds of failures and failure levels of the failures in association with each other as indicated in FIG. 4. In the example as indicated in FIG. 4, for example, “communication abnormality”, “indoor-space humidity sensor abnormality”, “indoor-space temperature sensor abnormality”, “indoor-space humidity abnormality”, and “indoor-space temperature abnormality” are indicated as examples of the kinds of failures. The second data tables 60 are provided for respective conditioning cooling energy apparatuses, that is, the air-conditioning cooling energy apparatuses 2A and 2B. In the following, the second data table 60 provided for the air-conditioning cooling energy apparatus 2A will be referred to as a second data table 60A, and the second data table 60 provided for the air-conditioning cooling energy apparatus 2B will be referred to as a second data table 60B. The second data table 60A and the second data table 60B are stored in the storage unit 102. It should be noted that it is described above that each of the second data tables 60 is provided for an associated one of the air-conditioning cooling energy apparatuses 2A and 2B; however, it is not limiting, and a single second data table 60 may be provided in common for the air-conditioning cooling energy apparatuses 2A and 2B.

The second data table 60A is transmitted from the communication unit 103 of the air-conditioning cooling energy apparatus management apparatus 1A to the air-conditioning cooling energy apparatus 2A through the communication line 3A. The air-conditioning cooling energy apparatus 2A includes the storage device 20A therein as illustrated in FIG. 1. The air-conditioning cooling energy apparatus 2A stores the received second data table 60A in the storage device 20A. Similarly, the second data table 60B is transmitted from the communication unit 103 of the air-conditioning cooling energy apparatus management apparatus 1A to the air-conditioning cooling energy apparatus 2B through the communication line 3A. The air-conditioning cooling energy apparatus 2B includes the storage device 20B therein as illustrated in FIG. 1. The air-conditioning cooling energy apparatus 2B stores the received second data table 60B in the storage device 20B.

In the example as indicated in FIG. 4, in the second data tables 60A and 60B, the failure level of “indoor-space temperature abnormality” is level 4, the failure level of “indoor-space humidity abnormality” is level 3, the failure levels of “indoor-space temperature sensor abnormality” and “indoor-space humidity sensor abnormality” are level 2, and the failure level of “communication abnormality” is level 1.

In the case where the first control information and the second control information are set, first, the user performs a preset operation on the setting input unit 101 to cause the display unit 105 to display an input section for inputting the first control information. The input section is displayed in a table format as in, for example, the first data table 50A as indicated in FIG. 3. Next, the user inputs the first control information to the setting input unit 101 using the input section. As a result, in the first data table 50A as indicated in FIG. 3, a transmission destination or transmission destinations to which notification information is to be transmitted are set for each of failure levels. Moreover, the user performs a preset operation on the setting input unit 101 to cause the display unit 105 to display an input section for inputting the second control information. The input section is displayed in a table format similar to, for example, that of the second data tables 60A and 60B as illustrated in FIG. 4. Next, the user inputs the second control information to the setting input unit 101 using the input section. The user performs this operation for each of the second data tables 60A and 60B. As a result, in each of the second data tables 60A and 60B as indicated in FIG. 4, a failure level is set for each of kinds of failures. It should be noted that levels 1 to 4 indicated as failure levels in the second data tables 60A and 60B correspond to levels 1 to 4 indicated as failure levels in FIG. 3, respectively. It should be noted that in this case, the user is a person who is allowed to operate the air-conditioning cooling energy apparatus management apparatus 1A, and is, for example, a responsible person of the maintenance contractor, a person in the maintenance contractor who is in charge of the building A, or an administrator of the building A.

[Operation at Time at which Level-1 Failure Occurs]

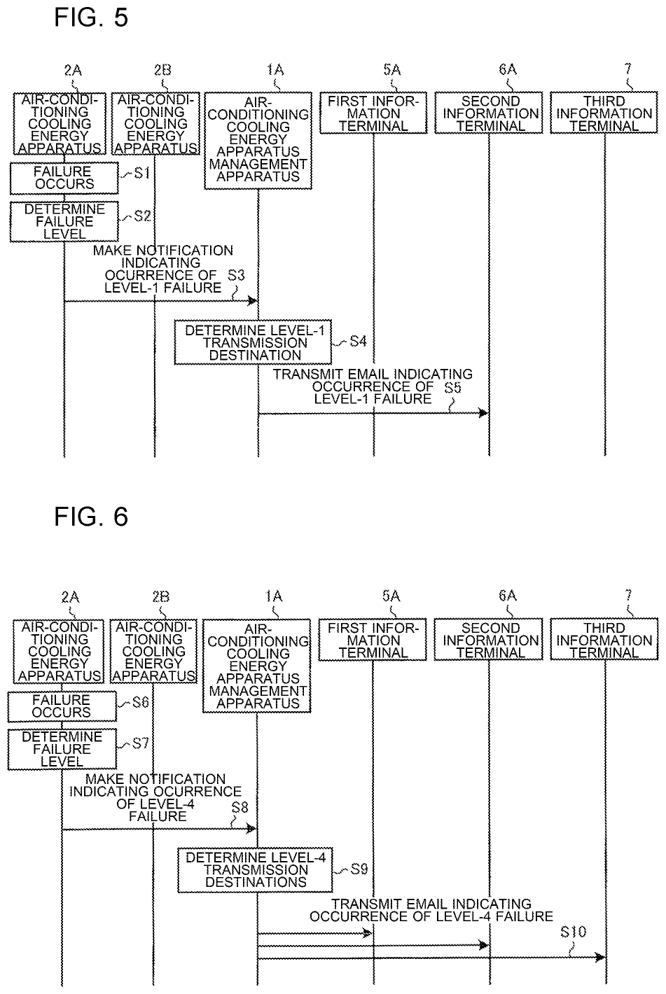

The operation to be performed in the case where a level-1 failure that is a failure whose failure level is level 1 occurs will be described with reference to FIG. 5. FIG. 5 is a timing chart indicating a procedure of processing that is performed by the air-conditioning cooling energy apparatus management apparatus 1A according to Embodiment 1, when a level-1 failure occurs.

It is assumed that as indicated in FIG. 5, in step S1, a failure of “communication abnormality” occurs in in the air-conditioning cooling energy apparatus 2A.

In this case, in step S2, the air-conditioning cooling energy apparatus 2A determines the kind of the failure on the basis of detection signals from various sensors or detection signals from various units of the air-conditioning cooling energy apparatus 2A. The various sensors are provided at, for example, a main body of the air-conditioning cooling energy apparatus 2A, a remote control unit of the air-conditioning cooling energy apparatus 2A, the communication line 3A, and the building A. In this case, since the failure of “communication abnormality” occurs, the air-conditioning cooling energy apparatus 2A determines the kind of the failure as “communication abnormality.” Next, the air-conditioning cooling energy apparatus 2A determines a failure level in accordance with the kind of the failure by referring to the second data table 60A stored in the storage device 20A. In this case, since the failure of “communication abnormality” occurs, the air-conditioning cooling energy apparatus 2A determines the failure level as level 1 by referring to the second data table 60A.

Next, in step S3, the air-conditioning cooling energy apparatus 2A transmits a signal indicating occurrence of a level-1 failure to the air-conditioning cooling energy apparatus management apparatus 1A via the communication line 3A. In this case, the air-conditioning cooling energy apparatus 2A transmits the signal with identification information thereof added to the signal, such that an apparatus where the failure occurs can be identified.

Next, in step S4, the communication unit 103 of the air-conditioning cooling energy apparatus management apparatus 1A receives the signal indicating occurrence of the level-1 failure from the air-conditioning cooling energy apparatus 2A. On the basis of the failure level indicated by the signal received by the communication unit 103, the transmission destination determination unit 104 of the air-conditioning cooling energy apparatus management apparatus 1A determines a notification-information transmission destination or destinations by referring to the first data table 50A stored in the storage unit 102. In this case, since the failure level is level 1, the air-conditioning cooling energy apparatus management apparatus 1A determines the notification-information transmission destination as the second information terminal 6A by referring to the first data table 50A.

Next, in step S5, the air-conditioning cooling energy apparatus management apparatus 1A transmits notification information indicating occurrence of a level-1 failure in the air-conditioning cooling energy apparatus 2A to the second information terminal 6A via the network 4.

Although the operation that is performed in the case where a failure occurs in the air-conditioning cooling energy apparatus 2A is described above, a similar operation is also performed in the case where a failure occurs in the air-conditioning cooling energy apparatus 2B, and its description will thus be omitted.

[Operation at Time at which Level-4 Failure Occurs]

The operation to be performed in the case where a level-4 failure, that is, a failure whose failure level is level 4, occurs will be described with reference to FIG. 6. FIG. 6 is a timing chart indicating a procedure of processing that is performed by the air-conditioning cooling energy apparatus management apparatus 1A according to Embodiment 1, when a level-4 failure occurs.

It is assumed that as indicated in FIG. 6, in step S6, a failure of “indoor-space temperature abnormality” occurs in the air-conditioning cooling energy apparatus 2A.

In this case, in step S7, the air-conditioning cooling energy apparatus 2A determines the kind of the failure on the basis of detection signals from the various sensors or detection signals from the various units of the air-conditioning cooling energy apparatus 2A. In the above case, since the failure of “indoor-space temperature abnormality” occurs, the air-conditioning cooling energy apparatus 2A determines “indoor-space temperature abnormality” as the kind of the failure. Next, the air-conditioning cooling energy apparatus 2A determines a failure level based on what failure occurs, by referring to the second data table 60A stored in the storage device 20A. In the above case, since the failure of “indoor-space temperature abnormality” occurs, the air-conditioning cooling energy apparatus 2A determines the failure level as level 4 by referring to the second data table 60A.

Next, in step S8, the air-conditioning cooling energy apparatus 2A transmits a signal indicating occurrence of a level-4 failure to the air-conditioning cooling energy apparatus management apparatus 1A via the communication line 3A. In this case, the air-conditioning cooling energy apparatus 2A transmits the signal with identification information thereof added to the signal, such that an apparatus in which the failure occurs can be identified.

Next, in step S9, the communication unit 103 of the air-conditioning cooling energy apparatus management apparatus 1A receives the signal indicating occurrence of the level-4 failure from the air-conditioning cooling energy apparatus 2A. On the basis of the failure level indicated by the signal received by the communication unit 103, the transmission destination determination unit 104 of the air-conditioning cooling energy apparatus management apparatus 1A determines a notification-information transmission destination or notification-information transmission destinations by referring to the first data table 50A stored in the storage unit 102. In the above case, since the failure level is level 4, the air-conditioning cooling energy apparatus management apparatus 1A determines the notification-information transmission destinations as the second information terminal 6A, the third information terminal 7, and the first information terminal 5A by referring to the first data table 50A.

Next, in step S10, the air-conditioning cooling energy apparatus management apparatus 1A transmits notification information indicating occurrence of the level-4 failure in the air-conditioning cooling energy apparatus 2A to the second information terminal 6A, the third information terminal 7, and the first information terminal 5A via the network 4.

Although the operation that is performed in the case where a failure occurs in the air-conditioning cooling energy apparatus 2A is described above, a similar operation is also performed in the case where a failure occurs in the air-conditioning cooling energy apparatus 2B, and its description will thus be omitted.

### [Change of Failure Level of Each Failure]

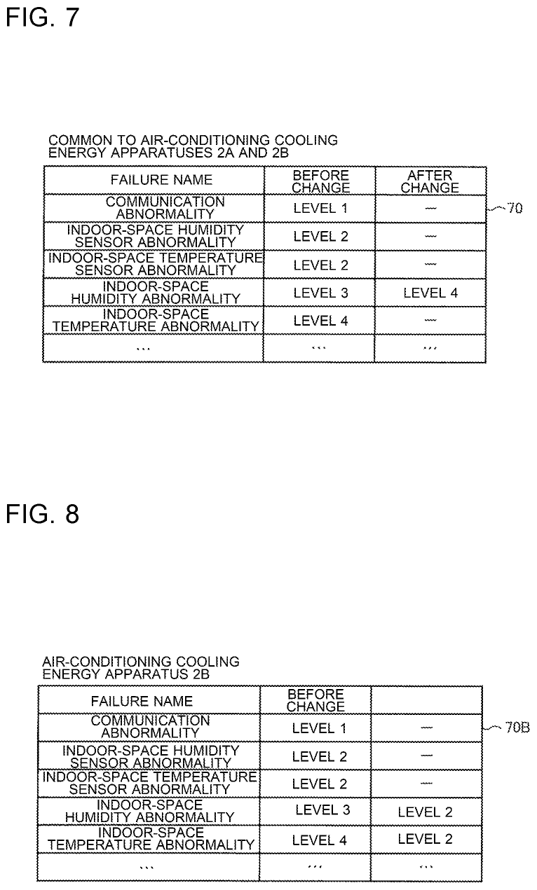

Next, an operation of changing a failure level in the second data tables 60 will be described with reference to FIG. 7. FIG. 7 is a diagram illustrating an example of an input section 70 that is used when a failure level is changed and displayed on the display unit 105 provided in the air-conditioning cooling energy apparatus management apparatus 1A according to Embodiment 1.

The failure levels are set in advance in the second data tables 60 through the initial setting described above. However, the user can arbitrarily change the failure levels of failures using the setting input unit 101 of the air-conditioning cooling energy apparatus management apparatus 1A. The following description is made referring to by way of example an operation that is performed in the case where the failure level of indoor-space humidity abnormality is changed from level 3 to level 4.

In the case where the user determines that, for example, an indoor-space humidity abnormality is an abnormality whose level of importance is high, the user operates the setting input unit 101 to cause the display unit 105 to display the input section 70 as illustrated in FIG. 7. The input section 70 is used in common for the air-conditioning cooling energy apparatuses 2A and 2B, and the failure levels in each of the second data tables 60A and 60B can be changed at once. For each failure kind, the input section 70 indicates a pre-change failure level and a field for inputting a post-change failure level alongside of the pre-change failure level, the pre-change failure level being a failure level that has not yet been changed, the post-change failure level being a failure level that has been changed. In the case where a pre-change failure level in the second data table 60A is different from that in the second data table 60B, the pre-change failure levels in the second data tables 60A and 60B are displayed side by side or a message indicating that the pre-change failure levels are different from each other is displayed. The user selects a failure for which the user wants to change its failure level, from a field for “failure name” of the input section 70, and inputs a post-change failure level of the selected failure in the input field of the input section 70. In the above case, since the user wants to change the failure level of “indoor-space humidity abnormality” from level 3 to level 4, the user thus selects “indoor-space humidity abnormality” from the field for “failure name” of the input section 70 and inputs “level 4” in the input field of the failure. As a result, the failure level in each of the second data tables 60A and 60B stored in the storage unit 102 can be changed. It should be noted that the in the above case, the user is a person who is allowed to operate the air-conditioning cooling energy apparatus management apparatus 1A and is, for example, the administrator of the building A.

An item or items changed through the input section 70 is transmitted from the communication unit 103 of the air-conditioning cooling energy apparatus management apparatus 1A to the air-conditioning cooling energy apparatuses 2A and 2B. The air-conditioning cooling energy apparatuses 2A and 2B update the failure levels in the second data tables 60A and 60B stored in the storage devices 20A and 20B, respectively, on the basis of the received changed items. In the case where an indoor-space humidity abnormality occurs in the air-conditioning cooling energy apparatus 2A or 2B after the above update, a notification indicating the abnormality whose failure level is level 4 is given from the air-conditioning cooling energy apparatus 2A or 2B to the air-conditioning cooling energy apparatus management apparatus 1A.

In such a manner, the setting input unit 101 receives, for each of the kinds of failures, a change input for changing a failure level in each of the second data tables 60A and 60B that store second control information. Furthermore, the setting input unit 101 updates, for each of the kinds of the failures, the failure levels in the second data tables 60A and 60B on the basis of the change input. As a result, by changing the failure levels of the failures, the user can freely set failures for which the user wants to receive notification information.

### [Change of Failure Level for Each Apparatus]

For each of the air-conditioning cooling energy apparatuses 2A and 2B, the user can arbitrarily change the failure levels in the second data tables 60A and 60B using the setting input unit 101 of the air-conditioning cooling energy apparatus management apparatus 1A. FIG. 8 is a diagram illustrating an example of an input section 70B that is used when failure levels displayed on the display unit 105 provided in the air-conditioning cooling energy apparatus management apparatus 1A according to Embodiment 1 are changed. The input section 70B is provided for the air-conditioning cooling energy apparatus 2B, and only the failure levels in the second data table 60B can be changed.

The following description is made referring to by way of example an operation that is performed in the case where the failure levels of the indoor-space humidity abnormality and indoor-space temperature abnormality in the second data table 60B are each changed to level 2.

In the case where the user determines that, for example, the degree of importance of the air-conditioning cooling energy apparatus 2B is low, the user operates the setting input unit 101 to cause the display unit 105 to display the input section 70B as indicated in FIG. 8. The input section 70B is provided for the air-conditioning cooling energy apparatus 2B as described above. In the displayed input section 70B, for each of failures, a pre-change failure level is indicated and a field for inputting a post-change failure level is displayed alongside of the pre-change failure level. The user selects a failure for which the user wants to change the failure level, from the item “failure name” of the input section 70B, and inputs a post-change failure level of the failure in the input field of the input section 70B. In the above case, since the user wants to change the failure level of “indoor-space humidity abnormality” from level 3 to level 2, the user selects “indoor-space humidity abnormality” from the item “failure name” of the input section 70B and inputs “level 2” in the input field of the failure. Furthermore, since the user wants to change the failure level of “indoor-space temperature abnormality” from level 4 to level 2, the user selects “indoor-space temperature abnormality” from the item “failure name” of the input section 70B, and inputs “level 2” in the input field of the failure. As a result, the above failure level in the second data table 60B stored in the storage unit 102 is changed.

The details of a change or changes made through the input section 70B are transmitted from the communication unit 103 of the air-conditioning cooling energy apparatus management apparatus 1A to the air-conditioning cooling energy apparatus 2B. The air-conditioning cooling energy apparatus 2B updates the failure levels in the second data table 60B stored in its storage device 20B on the basis of the received details of the change or changes. In the case where an indoor-space humidity abnormality or an indoor-space temperature abnormality occurs in the air-conditioning cooling energy apparatus 2B after the update, a notification indicating occurrence of an abnormality whose failure level is level 2 is given from the air-conditioning cooling energy apparatus 2B to the air-conditioning cooling energy apparatus management apparatus 1A.

Although the operation that is performed in the case where a failure level in the second data table 60B is changed is described above, a similar operation is also performed in the case where a failure level in the second data table 60A is changed, its description will thus be of omitted.

As described above, for each of the air-conditioning cooling energy apparatuses 2A and 2B, the setting input unit 101 receives, for a failure level in an associated one of the second data tables 60A and 60B that store the second control information, a change input for changing the failure level in accordance with the kind of the failure. Moreover, for each of the air-conditioning cooling energy apparatuses 2A and 2B, the setting input unit 101 updates the failure level in the associated one of the second data tables 60A and 60B in accordance with the kind of the failure on the basis of the change input. As a result, for each of the air-conditioning cooling energy apparatuses 2A and 2B, the user can arbitrarily change the failure level of each failure and can arbitrarily set a failure in each of the air-conditioning cooling energy apparatuses 2A and 2B, for which the user wants to receive notification information.

### Summary of Embodiment 1

As described above, in the air-conditioning cooling energy apparatus management apparatus 1A according to Embodiment 1, the user can arbitrarily determine, for each failure level, whether to receive notification information or not by setting the first control information and the second control information. Thus, the user is able to know only a failure or failures whose failure level or levels needs to be known by the user. Moreover, for each air-conditioning cooling energy apparatus, the user can arbitrarily set the kind of a failure or failures for which the user wants to receive notification information. As a result, only notification information regarding a failure or failures that user needs to know in kind is transmitted, and thus the number of notification information that the user receives can be reduced. It is therefore possible to prevent the user from overlooking notification information indicating a failure whose degree of importance is high. Furthermore, it is possible to reduce the user's work load for checking the notification information, and facilitate maintenance management. The user can change a failure level for each of the failure kinds and thus can arbitrarily change the kind of a failure or failures for which the user wants to receive notification information. Furthermore, the user can arbitrarily change the failure level of each of kinds of failures for each of the air-conditioning cooling energy apparatuses.

### Embodiment 2

An air-conditioning cooling energy apparatus management apparatuses according to Embodiment 2 will be described with reference to the figures.

### [Configuration of Management System]

FIG. 9 is a configuration diagram illustrating an example of the configuration of a management system in which air-conditioning cooling energy apparatus management apparatuses 1A and 1B according to Embodiment 2 are provided. Embodiment 2 is applied to the case where a building B is further added and a second information terminal 6B is also added because of addition of the building B. In this regard, Embodiment 2 is different from Embodiment 1. Thus, as illustrated in FIG. 9, the management system according to Embodiment 2 includes the air-conditioning cooling energy apparatus management apparatuses 1A and 1B, air-conditioning cooling energy apparatuses 2A, 2B, 2C, and 2D, first information terminals 5A and 5B, second information terminals 6A and 6B, and a third information terminal 7.

In Embodiment 2 also, the air-conditioning cooling energy apparatus management apparatus 1A, the air-conditioning cooling energy apparatuses 2A and 2B, and the first information terminal 5A are installed in the building A as in Embodiment 1. These apparatuses and terminal are the same as those in Embodiment 1, and their description will thus be omitted.

As illustrated in FIG. 9, the air-conditioning cooling energy apparatus management apparatus 1B, the air-conditioning cooling energy apparatuses 2C and 2D, and the first information terminal 5B are installed in the building B. The first information terminal 5B is used by the administrator of the building B. The air-conditioning cooling energy apparatuses 2C and 2D are each, for example, an air-conditioning apparatus that performs both cooling and heating, an air-conditioning apparatus that performs cooling only, a fan, or a dehumidifier. The air-conditioning cooling energy apparatus 2C includes a storage device 20C, and the air-conditioning cooling energy apparatus 2D includes a storage device 20D. In this case, the first information terminal 5B is a fixed terminal, but may be a mobile terminal that is carried by the administrator of the building B.

The second information terminals 6A and 6B and the third information terminal 7 are installed in an office of a maintenance contractor that performs maintenance of the air-conditioning cooling energy apparatuses 2A to 2D. The second information terminal 6A is used by a person in the maintenance contractor who is in charge of the building A. The second information terminal 6B is used by a person in the maintenance contractor who is in charge of the building B. The third information terminal 7 is used by a responsible person in the maintenance contractor. In this case, the second information terminals 6A and 6B are fixed terminals, but may be mobile terminals that are carried by respective persons in the maintenance contractor who are in charge of the buildings A and B. Similarly, the third information terminal 7 is a fixed terminal, but may be a mobile terminal that is carried by a responsible person in the maintenance contractor.

The configuration of the inside of the building A is similar to that of Embodiment 1. That is, in the building A, the air-conditioning cooling energy apparatus management apparatus 1A is connected to the air-conditioning cooling energy apparatuses 2A and 2B by the communication lines 3A. The communication lines 3A are installed in the building A. The air-conditioning cooling energy apparatus management apparatus 1A is connected to the first information terminals 5A and 5B, the second information terminals 6A and 6B, and the third information terminal 7 via the network 4.

Next, the configuration of the inside of the building B will be described. The configuration of the inside of the building B is similar to that of the building A. That is, in the building B, the air-conditioning cooling energy apparatus management apparatus 1B is connected to the air-conditioning cooling energy apparatuses 2C and 2D by communication lines 3B. The communication lines 3B are installed in the building B. The air-conditioning cooling energy apparatus management apparatus 1B is connected to the first information terminals 5A and 5B, the second information terminals 6A and 6B, and the third information terminal 7 via the network 4.

The network 4 may be an information network such as the Internet or may be a dedicated network provided between each of the buildings A and B and the maintenance contractor.

It is described above that the air-conditioning cooling energy apparatuses 2A, 2B, 2C, and 2D are provided, that is, the number of the air-conditioning cooling energy apparatuses is four; however, the number of the air-conditioning cooling energy apparatuses is not limited to four and may be any number. Furthermore, it is described above by way of example that the first to third information terminals 5A, 5B, 6A, 6B, and 7 are provided, that is, the number of the information terminals is five; however, the number of the information terminals is not limited to five and may be any number. In addition, the buildings A and B are described above; that is, the number of the buildings is two; however, the number of the buildings is not limited to two and may be any number.

The other configuration and operations of the management system according to Embodiment 2 are the same as those of Embodiment 1, and their descriptions will thus be omitted.

### [Operation of Air-Conditioning Cooling Energy Apparatus Management Apparatus]

Next, the operation of the air-conditioning cooling energy apparatus management apparatus 1B according to Embodiment 2 will be described.

### [Setting of Control Information]

A control information setting operation of the air-conditioning cooling energy apparatus management apparatus 1B will be described with reference to FIGS. 2, 10, and 11, the control information setting operation being performed using the setting input unit 101. The internal configuration of the air-conditioning cooling energy apparatus management apparatus 1B according to Embodiment 2 is the same as that of the air-conditioning cooling energy apparatus management apparatus 1A described above and as illustrated in FIG. 2, and its detailed description will thus be omitted and regarding the internal configuration, FIG. 2 should be referred to.

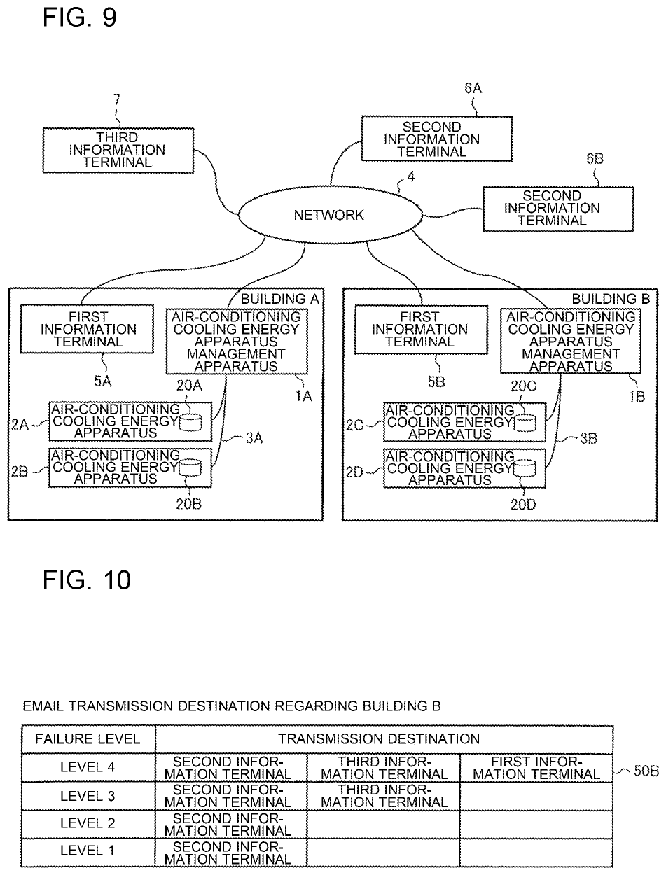

FIG. 10 is a diagram illustrating an example of a first data table 50B in which first control information set by the setting input unit 101 of the air-conditioning cooling energy apparatus management apparatus 1B according to Embodiment 2 is indicated. As indicated in FIG. 10, the first data table 50B indicates failure levels and transmission destinations of notification information as the first control information in association with each other. It should be noted that regarding the failure levels in the first data table 50B, level 1 indicates the most minor failure, and the higher the failure level, the higher the degree of importance of the failure. The failure levels are the same as those in Embodiment 1. In the example as indicated in FIG. 10, in the case where the failure level is level 4, the second information terminal 6A, the third information terminal 7, and the first information terminal 5A are set as the transmission destinations of notification information. In the case where the failure level is level 3, the second information terminal 6A and the third information terminal 7 are set as the transmission destinations of notification information. Furthermore, in the case where the failure level is 1 and the case where the failure level is 2, the second information terminal 6A is set as the transmission destination of notification information. The first data table 50B is stored in the storage unit 102 of the air-conditioning cooling energy apparatus management apparatus 1B.

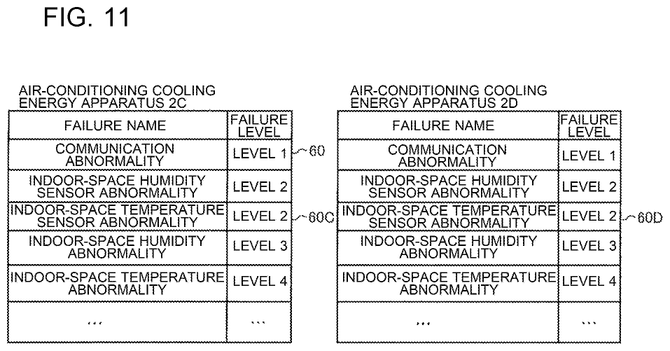

FIG. 11 is a diagram illustrating an example of each of second data tables 60 in which second control information set by the setting input unit 101 of the air-conditioning cooling energy apparatus management apparatus 1B according to Embodiment 2 is indicated. The second data tables 60 indicate, as the second control information, failure name information representing the kinds of failures and failure levels of the failures as indicated in FIG. 11 in association with each other. The second data tables 60 are provided for the respective air-conditioning cooling energy apparatuses; that is, the air-conditioning cooling energy apparatuses 2C and 2D. The second data table 60 provided for the air-conditioning cooling energy apparatus 2C will be referred to as a second data table 60C, and the second data table 60 provided for the air-conditioning cooling energy apparatus 2D will be referred to as a second data table 60D. The second data table 60C and the second data table 60D are stored in the storage unit 102 of the air-conditioning cooling energy apparatus management apparatus 1B. The second data table 60C is transmitted, through the communication line 3B, from the communication unit 103 of the air-conditioning cooling energy apparatus management apparatus 1B to the air-conditioning cooling energy apparatus 2C. The air-conditioning cooling energy apparatus 2C includes the storage device 20C therein as illustrated in FIG. 9. The air-conditioning cooling energy apparatus 2C stores the received second data table 60C in the storage device 20C. Similarly, the second data table 60D is transmitted, through the communication line 3B, from the communication unit 103 of the air-conditioning cooling energy apparatus management apparatus 1B to the air-conditioning cooling energy apparatus 2D. The air-conditioning cooling energy apparatus 2D includes the storage device 20D therein as illustrated in FIG. 9. The air-conditioning cooling energy apparatus 2D stores the received second data table 60D in the storage device 20D.

First, the user of the air-conditioning cooling energy apparatus management apparatus 1B sets, for each of failure levels in the first data table 50B as indicated in FIG. 10, a transmission destination or transmission destinations to which notification information is to be transmitted, by inputting data representing the first control information to the setting input unit 101. The user of the air-conditioning cooling energy apparatus management apparatus 1B sets, for each of the air-conditioning cooling energy apparatuses 2C and 2D, failure levels for the respective failures in the second data tables 60C and 60D as indicated in FIG. 11, by inputting the second control information to the setting input unit 101. It should be noted that levels 1 to 4 indicated as the failure levels in the second data tables 60C and 60D correspond to levels 1 to 4 indicated as the failure levels in FIG. 10, respectively. In the above case, the user is a person who is allowed to operate the air-conditioning cooling energy apparatus management apparatus 1B and is, for example, the administrator of the building B.

The operations in [Operation at Time at Which Level-1 Failure Occurs], [Operation at Time at Which Level-4 Failure Occurs], [Change of Failure Level of Each Failure], and [Change of Failure Level for Each Apparatus] in Embodiment 2 are the same as those in Embodiment 1 as described above, and their descriptions will thus be omitted.

In such a manner, in Embodiment 2, the first data tables 50A and 50B can be provided for the buildings A and B, respectively. Thus, the user can arbitrarily determine whether or not to receive notification information, based on the degree of importance of the building.

It is described above that in Embodiment 2, the first data tables 50A and 50B are provided for the buildings A and B, respectively, and regarding each of the buildings A and B, a transmission destination or transmission destinations of notification information can be changed; however, it is not limiting. That is, first data tables 50 may be provided for the respective air-conditioning cooling energy apparatuses 2A to 2D, and regarding each of the air-conditioning cooling energy apparatuses 2A to 2D, a transmission destination or transmission destinations of notification information may be able to be changed.

In Embodiment 2, the air-conditioning cooling energy apparatuses 2A and 2B installed in the building A belong to a first group, and the air-conditioning cooling energy apparatuses 2C and 2D installed in the building B belong to a second group. It is described above that the first data table 50A is provided for the first group and the first data table 50B is provided for the second group. However, in Embodiment 2, the air-conditioning cooling energy apparatuses 2A to 2D may be arbitrarily grouped regardless of which building each of them is installed in. That is, for example, grouping may be performed such that the air-conditioning cooling energy apparatus 2A of the building A and the air-conditioning cooling energy apparatus 2C of the building B belong to the first group, and the air-conditioning cooling energy apparatus 2B of the building A and the air-conditioning cooling energy apparatus 2D of the building B belong to the second group. Alternatively, grouping may be performed such that the air-conditioning cooling energy apparatuses 2A, 2B, and 2C belong to the first group, and the air-conditioning cooling energy apparatus 2D belongs to the second group.

In such a manner, in Embodiment 2, the air-conditioning cooling energy apparatuses 2A to 2D may be arbitrarily grouped to fall into two or more groups. In that case, the first data table 50 that indicates the first control information is provided for each of the groups. Furthermore, in this case, the air-conditioning cooling energy apparatus management apparatuses 1A and 1B belong to the respective groups. The user can do, to each of the setting input units 101 of the air-conditioning cooling energy apparatus management apparatuses 1A and 1B that belong to the respective groups, a change input for changing information on a transmission destination of notification information in the first data table 50. In the case where a change input is done, information on a transmission destination of notification information in the first data table is updated on the basis of the change input. In such a manner, in Embodiment 2, for each of the groups and each of the failure levels, information on a transmission destination or transmission destinations of notification information in the first data table 50 can be changed.

### Summary of Embodiment 2

As described above, with the air-conditioning cooling energy apparatus management apparatuses according to Embodiment 2, the user can freely determine whether to receive notification information in accordance with the degree of importance of the building. Thus, the user is able to know only a failure or failures having degrees of importance that the user needs to know. As a result, the number of notification information that the user receives can be reduced. It is therefore possible to prevent the user from overlooking notification information indicating occurrence of a failure whose degree of importance is high. Furthermore, it is possible to reduce the user's work load for checking notification information, and facilitate maintenance management.

Hardware configurations of the air-conditioning cooling energy apparatus management apparatuses 1A and 1B according to Embodiments 1 and 2 described above will be described.

The functions of the setting input unit 101, the communication unit 103, and the transmission destination determination unit 104 in the air-conditioning cooling energy apparatus management apparatuses 1A and 1B according to Embodiments 1 and 2 described above are individually fulfilled by processing circuits. The processing circuits that fulfill the respective functions may be dedicated hardware or may also be processors that execute programs stored in the memory.

In the case where the processing circuits are dedicated hardware, the processing circuits are, for example, single circuits, composite circuits, programmed processors, parallel-programmed processors, application specific integrated circuits (ASICs), field programmable gate arrays (FPGAs), or a combination of some or all of the above. The functions of the setting input unit 101, the communication unit 103, and the transmission destination determination unit 104 may be fulfilled by the respective processing circuits, or the functions of the units may be collectively fulfilled by a single processing circuit.

In contrast, in the case where the processing circuits are processors, the functions of each of the setting input unit 101, the communication unit 103, and the transmission destination determination unit 104 are fulfilled by software, firmware, or a combination of software and firmware. The software and the firmware are described as programs and stored in a memory. The processors read out and execute programs stored in the memory to fulfill the functions of the individual units. That is, the air-conditioning cooling energy apparatus management apparatuses 1A and 1B each include a memory that stores programs that carry out a setting input step, a communication step, and a transmission destination determination step when the programs are executed by the processing circuits.

It can be said that these programs are programs that cause a computer to execute the above procedures of the respective units or the above method. In this case, the memory may be a nonvolatile or volatile semiconductor memory such as, for example, a random access memory (RAM), a read only memory (ROM), a flash memory, an erasable programmable read only memory (EPROM), or an electrically erasable and programmable read only memory (EEPROM). Moreover, the memory may also be, for example, a magnetic disk, a flexible disk, an optical disc, a compact disc, a minidisc, or a digital versatile disc (DVD). The storage unit 102 includes a memory.

It should be noted that that some of the functions of the units described above may be fulfilled by dedicated hardware, or fulfilled by software or firmware.

In such a manner, the processing circuits can be made of hardware, software, firmware, or a combination of some or all of the hardware, the software, and the firmware, and can fulfill the functions of the units as described above.

It should be noted that it is described above that in Embodiments 1 and 2, the air-conditioning cooling energy apparatus 2A determines a failure level in step S2 as indicated in FIG. 5 and in step S7 as indicated in FIG. 6; however, it is not limiting. That is, a failure level may be determined by the air-conditioning cooling energy apparatus management apparatuses 1A and 1B, not the air-conditioning cooling energy apparatuses 2A to 2D. In this case, in the case where a failure occurs in one or more of the air-conditioning cooling energy apparatuses 2A to 2D, the one or more of the air-conditioning cooling energy apparatuses 2A to 2D determine the kind of the failure and send signals indicating the kind of the failure to the air-conditioning cooling energy apparatus management apparatuses 1A and 1B. When receiving the signals indicating the kind of the failure from the air-conditioning cooling energy apparatuses 2A to 2D, the air-conditioning cooling energy apparatus management apparatuses 1A and 1B determine the failure level of the failure by referring to the second data tables 60A to 60D stored in the storage units 102.

Regarding Embodiments 1 and 2, the descriptions are made referring to by way of example the air-conditioning cooling energy apparatuses as apparatuses installed in the building A or the building B; however, they are not limiting regarding Embodiments 1 and 2. That is, each of the air-conditioning cooling energy apparatus management apparatuses 1A and 1B according to Embodiments 1 and 2 can be applied not only to management of air-conditioning cooling energy apparatuses but also to management of any kinds of apparatuses installed in an associated one of the buildings. In the above case also, needless to say, similar advantages to those as described above can be obtained.

1. An air-conditioning cooling energy apparatus management apparatus comprising:
a setting input unit configured to set control information for use in determination of a transmission destination of notification information indicating occurrence of a failure in two or more air-conditioning cooling energy apparatuses, when the control information is input to the setting input unit;
a storage unit configured to store the control information set by the setting input unit;
a communication unit configured to receive information on the failure from the air-conditioning cooling energy apparatuses and transmit the notification information indicating occurrence of the failure; and
a transmission destination determination unit configured to determine the transmission destination of the notification information on the basis of the control information and a failure level based on the information on the failure that is received by the communication unit,
wherein
the communication unit is configured to transmit the notification information to the transmission destination determined by the transmission destination determination unit, when receiving the information on the failure from the air-conditioning cooling energy apparatuses;
the control information is first control information in which a correspondence relationship between the failure level of the failure and the transmission destination of the notification information is determined,
the air-conditioning cooling energy apparatuses are grouped to fall into two or more groups,
the first control information is provided for each of the air-conditioning cooling energy apparatuses, and
the setting input unit is configured receive a change input for use in changing the transmission destination of the notification information in the first control information regarding each of the groups of the air-conditioning cooling energy apparatuses and each of failure levels, and update the transmission destination of the notification information in the first control information stored in the storage unit on the basis of the change input.

2. (canceled)

3. The air-conditioning cooling energy apparatus management apparatus of claim 1, wherein
the control information includes second control information in which a correspondence relationship between a kind of the failure and the failure level of the failure is determined,
the communication unit is configured to transmit the second control information to the air-conditioning cooling energy apparatuses and receive the information on the failure that is transmitted from the air-conditioning cooling energy apparatuses based on the second control information, and
the transmission destination determination unit is configured to determine the transmission destination of the notification information on the basis of the first control information and the failure level transmitted from the air-conditioning cooling energy apparatuses and received by the communication unit.

4. The air-conditioning cooling energy apparatus management apparatus of claim 1, wherein
the control information includes second control information in which a correspondence relationship between a kind of the failure and the failure level of the failure is determined,
the communication unit is configured to receive the information on the failure from the air-conditioning cooling energy apparatuses, the information including the kind of the failure, and
the transmission destination determination unit is configured to determine the failure level of the failure on the basis of the second control information stored in the storage unit and the kind of the failure that is transmitted from the air-conditioning cooling energy apparatuses and received by the communication unit, and determine the transmission destination of the notification information on the basis of the first control information stored in the storage unit and the determined failure level.

5. The air-conditioning cooling energy apparatus management apparatus of claim 3, wherein the setting input unit is configured to receive a change input for use in changing the failure level in the second control information regarding each of kinds of failures, and updates the failure level in the second control information on the basis of the change input.

6. The air-conditioning cooling energy apparatus management apparatus of claim 3, wherein
the second control information is provided for each of the air-conditioning cooling energy apparatuses, and
the setting input unit is configured to receive a change input for use in changing the failure level in the second control information regarding each of the air-conditioning cooling energy apparatuses and each of kinds of failures, and updates the failure level in the second control information stored in the storage unit on the basis of the change input.

7-8. (canceled)

9. The air-conditioning cooling energy apparatus management apparatus of claim 4, wherein
the first information is indicated in a first data table,
the second information is indicated in a second data table, and
failure levels in the second data table correspond to respective failure levels in the first data table.

10. The air-conditioning cooling energy apparatus management apparatus of claim 9, wherein
kinds of failures include a communication abnormality, an indoor-space humidity sensor abnormality, an indoor-space temperature sensor abnormality, an indoor-space humidity abnormality, and an indoor-space temperature abnormality.

11. The air-conditioning cooling energy apparatus management apparatus of claim 9, further comprising a display unit,
wherein when the setting input unit receives a change input for changing the failure level in the second information, for each of kinds of failures, the display unit displays an input section that indicates a pre-change failure level and a field for inputting a post-change failure level, on the basis of the change input, the pre-change failure level being a failure level that has not yet been changed, the post-change failure level being a failure level that has been changed.

12. The air-conditioning cooling energy apparatus management apparatus of claim 11, when in the input section displayed by the display unit, a kind of a failure whose failure level is to be changed is selected from kinds of failures that are indicated in the input section, and the post-change failure level is input to an input field for the selected kind of the failure, the setting input unit changes the failure level indicated in the second data table to the input post-change failure level.
